(19) United States
(12) Patent Application Publication
(10) Pub. No.: US 2026/0351755 A1
(43) Pub. Date: Nov. 5, 2026

(54) SILICONE FOAM MATERIAL FOR BATTERY FIRE PROTECTION

(71) Applicant: DOW SILICONES CORPORATION, Midland, MI (US)

(72) Inventors: Xuesi YAO, Shanghai (CN); Minbiao HU, Shanghai (CN); Xiangyang TAI, Shanghai (CN); Lu ZOU, Shanghai (CN); Yi GUO, Shanghai (CN)

(21) Appl. No.: 19/153,593

(22) PCT Filed: Feb. 6, 2023
(86) PCT No.: PCT/CN2023/074512

§ 371 Date: Aug. 4, 2025

(51) Int. Cl. H01M 50/24; A62C 2/06; H01M 50/209; H01M 50/211; H01M 50/293; H01M 50/588

(52) U.S. Cl. CPC H01M 50/24; A62C 2/06; H01M 50/209; H01M 50/211; H01M 50/293; H01M 50/588

(57) ABSTRACT

A silicone-based fire protection material is disclosed. The silicone-based fire protection material has a foam structure in which hollow fillers having a d₅₀ of 10-200 microns are bound in a silicone-based polymeric foam comprising gas bubbles. The silicone-based fire protection material has a density of 0.1 g/cc to 0.8 g/cc and a Shore A hardness of 1-40. The silicone-based polymeric foam has a gas bubble size d₅₀ of 10-1000 microns. A battery package structure having the silicone-based fire protection material and related methods are also disclosed.

### FIELD OF TECHNOLOGY

The present disclosure relates to a silicone-based fire protection material, its production process and battery package structure having the material; relates to the use of silicone-based fire protection material in the battery package structure; and relates to a method for producing the battery package structure using the silicone-based fire protection material.

### BACKGROUND ART

Driven by the development of Li-ion battery technology, the automobile industry has been significantly changed by electric vehicle (EV) over the last decade. However, thermal runaway of EV battery can lead to severe fire risk and hazard, which has become a major safety concern. EV high-energy density battery thermal runaway temperature will go up to 600 °C or above. Few polymer composites could survive such high temperature. Thermal insulation materials are utilized to minimize EV battery thermal runaway propagation nowadays. Superior thermal insulation, high flame retardancy, light weight and good electrical insulation performance are required.

There are two known silicone solutions being used to mitigate battery thermal runaway. One is silicone foams that are normally chemically blown but can be physically blown also, and the other is silicone rubber syntactic foams with hollow glass beads incorporated. Both are effective to some extent but have limitations.

Silicone foam pad, either chemically blown or physically blown, is too soft for prismatic-cell and pouch-cell battery modules thermal runaway protection. Due to the expansion of battery during thermal runaway process, the silicone foam may be compressed excessively, leading to poor performance in thermal insulation. Silicone rubber syntactic foams are, on the other hand, basically incompressible. This is acceptable in many cylindrical cell arrays but detrimental for prismatic and pouch cells, as the latter experience a much significant expansion and contraction when they go through the charging and discharging cycles. In addition, the density of the rubber can still be too high, and often the flammability resistance is less than needed.

U.S. patent Ser. No. 10/501,597B2 disclosed a silicone rubber syntactic foam comprising a silicone rubber binder and hollow glass beads, and said silicone rubber syntactic foam fills partially or fully open space of said battery module casing and/or covering partially or totally said battery cells and/or covering partially or totally said module casing, and optionally a lid covering the battery module casing, wherein said silicone rubber syntactic foam is obtained by curing an addition curing type organopolysiloxane composition X, and wherein the addition curing type organopolysiloxane composition comprises: a) at least one organopolysiloxane A having at least two alkenyl groups bonded to silicon per molecule, said alkenyl groups each containing from 2 to 14 carbon atoms, b) at least one silicon compound B having at least two hydrogen atoms bonded to silicon per molecule, c) hollow glass beads D and d) a hydrosilylation catalyst C. While above silicone rubber syntactic foam has its own problems as below:
a. in order to achieve low density, high content of hollow glass beads is needed; meanwhile high content of hollow glass bead would result in high viscosity made it difficult to be processed; so the density of syntactic foam cannot be very low; that limits its thermal insulation during thermal runaway event; and
b. lack of cushion; its compression strain is low due to the fact that hollow glass beads can not endure obvious deformation; minimum compression strain is demanded to absorb the original thickness variation of cells during assembly, and to allow thickness change during charge-discharge cycling of cells.

### RELATED ART DOCUMENTS

1. U.S. Ser. No. 10/501,597B2

### SUMMARY OF THE INVENTION

### Problem Solved by the Present Invention

The problem to be solved by the invention is how to increase thermal insulation performance during thermal runaway, and provide good cushion performance while maintaining good processability. The concept of the present invention is a silicone-based fire protection material, preferably in the shape of sheet (pad) having a foam structure in which hollow fillers are bound in a silicone-based polymeric foam comprising gas bubbles, which is used in a battery pack. With both gas bubbles and hollow glass beads in the silicone rubber matrix, the cured and foamed composite can provide better balance among thermal insulation performance, cushion performance and processability for EV battery pack application.

### Means for Solving the Problem

As the result of earnest research, the present inventors arrived at the present invention through discovering that the problem described above can be solved through a silicone-based fire protection material having a foam structure in which hollow fillers having a d₅₀ of 10-200 microns are bound in a silicone-based polymeric foam comprising gas bubbles, wherein the silicone-based fire protection material has a density of 0.1 g/cc to 0.8 g/cc and a Shore A hardness of 1-40, and the silicone-based polymeric foam has a gas bubble size d₅₀ of 10-1000 microns.

In the silicone-based fire protection material described above, the hollow fillers have a volume fraction of 1-60%, based on total volume of the silicone-based fire protection material. In some embodiments of the present disclosure, the gas bubbles have a volume fraction of 5-90%, based on total volume of the silicone-based fire protection material. In some embodiments of the present disclosure, the hollow fillers are selected from hollow glass beads, aerogel particles, perlite beads, hollow ceramic beads, floating beads and polymer hollow beads. In some embodiments of the present disclosure, the silicone-based polymeric foam is obtained by curing a curable silicone-based composition comprising: a) at least one organopolysiloxane having at least two alkenyl groups bonded to silicon per molecule, b) at least one silicone crosslinker having at least two and optionally at least three hydrogen atoms bonded to silicon per molecule, c) hollow fillers, d) a hydrosilylation catalyst, and e) a gas blowing agent. In some embodiments of the present disclosure, the curable silicone-based composition further comprises: f) at least one additive selected from an inhibitor which slows curing rate, a reactive diluent which reacts through hydrosilylation reaction, a pigment, a dye, clays, a surfactant, hydrogenated castor oil, wollastonite, aluminium trihydrate, magnesium hydroxide, halloysite, huntite hydromagnesite, expandable graphite, zinc borate, mica and a fumed silica. In some embodiments of the present disclosure, the curable silicone-based composition further comprises: g) at least one selected from the group consisting of a flame-retardant additive, a curing catalyst, a rheology modifier, a wetting-additive, a surface treatment agent, a colorant, a filler other than the hollow filler, an anti-oxidant additive, a biocide, a ultraviolet (UV) stabilizer additive and an adhesion promoter additive. In some embodiments of the present disclosure, the silicone-based fire protection material is applied for a battery package. In some embodiments of the present disclosure, the silicone-based fire protection material exhibits a compression strain of ≥10% at 200 kPa.

Further, the present disclosure provides a battery package structure where said silicone-based fire protection material is fully or partially arranged into a space between at least two adjacent individual battery cells. In some embodiments of the present disclosure, the shape of battery cell is prismatic or pouch.

In the battery package structure described above, the silicone-based fire protection material is silicone-based which is cured prior to its arranging into the space between at least two adjacent individual battery cells.

In some embodiments of the present disclosure, said silicone-based fire protection material is a cured silicone-based product through curing reaction of curable silicone-based composition in the space between at least two adjacent individual battery cells.

Further, the present disclosure provides a curable silicone-based composition, which forms into said silicone-based fire protection material through curing reaction, comprising:
a) at least one organopolysiloxane having at least two alkenyl groups bonded to silicon per molecule,
b) at least one silicone crosslinker having at least two and optionally at least three hydrogen atoms bonded to silicon per molecule,
c) hollow fillers,
d) a hydrosilylation catalyst, and
e) a gas blowing agent.

In some embodiments of the present disclosure, the alkenyl groups each comprises from 2 to 14 carbon atoms. Optionally, the alkenyl groups are chosen from the group consisting of vinyl, allyl, hexenyl, decenyl and tetradecenyl. Preferably, said alkenyl groups are vinyl groups.

Further, the present disclosure provides a method of producing the silicone-based fire protection material, comprising following steps:
Step (I): a step of providing Part A comprising a) at least one organopolysiloxane having at least two alkenyl groups bonded to silicon per molecule and e) a gas blowing agent;
Step (II): a step of providing Part B comprising b) at least one silicone crosslinker having at least two hydrogen atoms bonded to silicon per molecule and optionally e) a gas blowing agent being a physical blowing agent;
Step (III): a step of mixing Part A with Part B to form the curable silicone-based composition;
Step (IV): a step of coating the curable silicone-based composition as wet-slurry layer onto a substrate which optionally have a release layer, and
Step (V): a step of forming the silicone-based fire protection material by curing and foaming the curable silicone-based composition as coated.

In some embodiments of the present disclosure, the thickness of the wet-slurry layer of the curable silicone-based composition ranges from 0.2 to 10.0 mm in said Step (IV). The method of producing said silicone-based fire protection material further comprises the step of controlling the viscosity and/or flowability of the curable silicone-based composition by adding a rheology modifier before or at the same timing of said Step (IV).

Further, the present disclosure provides a method of producing the battery package structure comprising following steps:
Step (B-I): a step of filling a space between at least two adjacent individual battery cells fully or partially with the curable silicone-based composition as wet-slurry, and
Step (B-II): a step of forming a silicone-based fire protection material in the space between at least two adjacent individual battery cells by curing and foaming the curable silicone-based composition as coated.

### Effects of the Invention

The present invention makes it possible to produce a silicone-based fire protection material, preferably sheet, which exhibits low density of ≤0.8 g/cc and compression strain≥10% at 200 kPa. According to thermal insulation test described in the present disclosure, the back face temperature of the silicone-based fire protection material is lower than reference samples. Due to relatively lower loading of the hollow fillers for achieving same or comparable density, the silicone-based fire protection material of the present invention exhibits better processability compared with those in the prior arts, e.g., in which all of the voids was created by hollow fillers, the viscosity would be too high to be processed. Also, the silicone-based fire protection material exhibits high volume resistance of >10¹⁵ ohm*m.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic diagram of an apparatus for testing thermal insulation performance of the silicone-based fire protection material according to the present disclosure.

FIG. 2 is back temperature curve of Example IE-1 according to the present invention.

FIG. 3 shows gas bubbles and hollow fillers in the silicone-based polymeric foam according to the present invention.

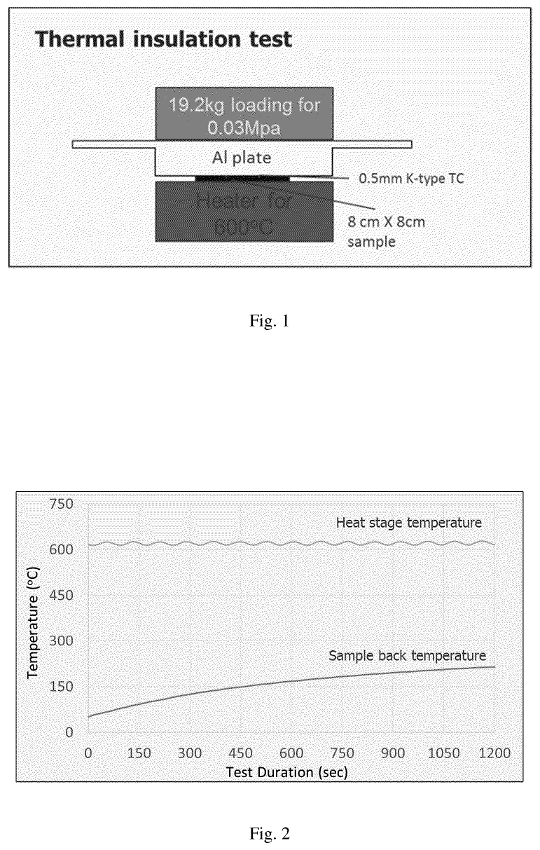

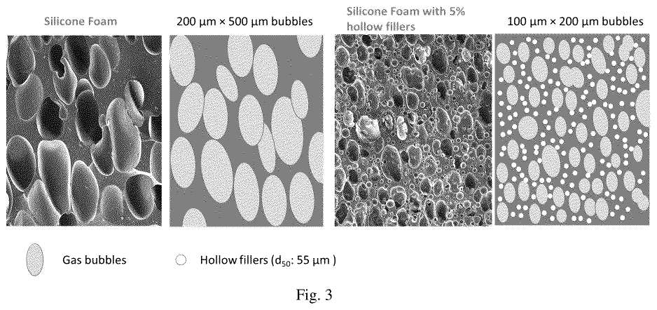

### DESCRIPTION OF THE PREFERRED EMBODIMENTS

Unless defined otherwise, all technical and scientific terms used herein have the same meaning as commonly understood by one of ordinary skill in the art to which the invention belongs. As disclosed herein, “and/or” means “and, or as an alternative” or “additionally or alternatively”. All ranges include endpoints unless otherwise indicated.

As used herein, the term “sheet” or “pad” means a flat product in form of pad or sheet which has a thickness. In general, the “sheet” or “pad” includes pad-form, sheet-form and other flat-form products having various thickness.

As used herein, the term “hollow filler” is understood to mean particles having a dense or low porosity shell and a free space within the shell. The hollow filler according to the present invention have a shell in which the thickness thereof can be controlled.

As used herein, the term “thickness” refers to an average of at least three measurements of a dried sheet (e.g., a sheet having a thickness of 0.2-10.0 mm) as measured using an Ames Gage, Model 13C-B2600 (Ames Corporation Waltham Mass).

As used herein, the terms “aerogel” and “aerogel particles” describe a class of structures having a low density, open cell structures, large surface areas, and nanometer scale pore sizes. Aerogel particles are provided at least in powder, granular, bead, and other suitable forms, and include inorganic, organic, and hybrid organic-inorganic compositions, or some combination of the above forms and/or compositions.

As used herein, the term “aerogel” denotes, in the present invention, gels obtained in a known way by the sol-gel route, which have been dried. This wording encompasses both aerogels proper, obtained by supercritical drying of the formed gels, but also gels commonly called “xerogels” obtained by evaporative drying at atmospheric pressure. Xerogels, due to their low cost, are very advantageous when large scale production of the materials of the present invention is considered, while aerogels exhibit more advantageous technical properties but have a high production cost.

As used herein, the term “polymer” or “polymeric” refers, in the alternative, to a polymer made from one or more different monomers, such as a copolymer, a terpolymer, a tetrapolymer, a pentapolymer etc., and may be any of a random, block, graft, sequential or gradient polymer.

As used herein, the term “d₅₀” means median particle/pore size, which can be measured by sieving method, for example, the expression “d₅₀ of 200 μm” means that 50% of the particles/pores of the hollow fillers/gas bubbles have a particle/pore size of 200 μm or more, and 50% of the particles/pores of the hollow fillers/gas bubbles have a particle/pore size of less than 200 μm.

To effectively mitigate battery thermal runaway, the present invention provides a silicone foam, either chemically or physically blown, with hollow fillers, for example, being selected from hollow glass beads, aerogel particles, perlite beads, floating beads and polymer hollow beads.

In accordance with the present invention, the silicone-based fire protection material has a foam structure in which hollow fillers are bound in a silicone-based polymeric foam comprising gas bubbles. The hollow fillers having a d₅₀ of 10-200 microns, 10-150 microns, 10-100 microns, 10-50 microns, 50-200 microns, 50-150 microns, 50-100 microns, 100-200 microns, 100-150 microns or 150-200 microns. The silicone-based fire protection material has a density of 0.1 g/cc to 0.8 g/cc, 0.1 g/cc to 0.6 g/cc, 0.1 g/cc to 0.4 g/cc, 0.1 g/cc to 0.2 g/cc, 0.2 g/cc to 0.8 g/cc, 0.2 g/cc to 0.6 g/cc, 0.2 g/cc to 0.4 g/cc, 0.4 g/cc to 0.8 g/cc, 0.4 g/cc to 0.6 g/cc, or 0.6 g/cc to 0.8 g/cc. The silicone-based fire protection material has a Shore A hardness of 1-40, 1-35, 1-30, 1-25, 1-20, 1-10, 1-5, 5-40, 5-35, 5-30, 5-25, 5-20, 5-10, 10-40, 10-35, 10-30, 10-25, 10-20, 20-40, 20-35, 20-30, 20-25, 30-40, 30-35, 25-35 or 35-40. The silicone-based polymeric foam has a gas bubble size d₅₀ of 10-1000 microns, 10-800 microns, 10-600 microns, 10-400 microns, 10-200 microns, 10-100 microns, 10-50 microns, 50-1000 microns, 50-800 microns, 50-600 microns, 50-400 microns, 50-200 microns, 50-100 microns, 100-1000 microns, 100-800 microns, 100-600 microns, 100-400 microns, 100-200 microns, 200-1000 microns, 200-800 microns, 200-600 microns, 200-400 microns, 400-1000 microns, 400-800 microns, 400-600 microns, 600-1000 microns, 600-800 microns or 80-1000 microns.

In the present invention, the hollow fillers are at least one selected from hollow glass beads, aerogel particles, perlite beads, hollow ceramic beads, floating beads and polymer hollow beads. In some embodiments, the hollow glass beads are hollow borosilicate glass microspheres.

In some embodiments, the hollow fillers have a volume fraction of 1-60%, 1-50%, 1-400%, 1-30%, 1-20%, 1-10%, 1-5%, 5-60%, 5-50%, 5-40%, 5-30%, 5-20%, 5-10%, 10-60%, 10-50%, 10-40%, 10-30%, 10-20%, 20-60%, 20-50%, 20-40%, 20-30%, 30-60%, 30-50%, 30-40%, 40-60%, 40-50% or 50-60%, based on total volume of the silicone-based fire protection material. Alternatively, the hollow fillers in dried silicone-based fire protection material has a loading of from 1 vol % to 20 vol %, from 1 vol % to 15 vol %, from 1 vol % to 10 vol %, from 1 vol % to 5 vol %, from 5 vol % to 20 vol %, from 5 vol % to 15 vol %, from 5 vol % to 10 vol %, from 10 vol % to 20 vol %, from 10 vol % to 15 vol % or from 15 vol % to 20 vol %.

In some embodiments, the gas bubbles have a volume fraction of 5-90%, 5-50%, 5-40%, 5-30%, 5-20%, 5-10%, 10-60%, 10-50%, 10-40%, 10-30%, 10-20%, 20-60%, 20-50%, 20-40%, 20-30%, 30-60%, 30-50%, 30-40%, 40-60%, 40-50% or 50-90%, based on total volume of the silicone-based fire protection material.

In the present invention, the aerogel particles can be provided in any suitable form, such as granular, powder, and bead form. The chemical compositions of aerogel particles include inorganic, organic, hybrid organic-inorganic compositions, or any combination thereof. Any combination of the above-mentioned forms and/or compositions can be used in the present invention. Optionally, the aerogel particles can be coated with one or more materials such as a polymer or elastomer, or treated with a treating agent such as a silane. A variety of different aerogel compositions can be used, including inorganic, organic, and hybrid organic-inorganic compositions. Inorganic aerogels are generally based upon metal oxide compounds including, but not limited to: silica, titania, zirconia, alumina, hafnia, yttria, or based on various carbides, nitrides or any combination of the preceding. Organic aerogels can be based on compounds including, but not limited to: urethanes, resorcinol formaldehydes, polyimide, polyacrylates, chitosan, polymethyl methacrylate, members of the acrylate family of oligomers, trialkoxysilyl terminated polydimethylsiloxane, polyoxyalkylene, polyurethane, polybutadiene, a member of the polyether family of materials or combinations thereof. Examples of organic-inorganic hybrid aerogels include, but are not limited to: silica-PMMA, silica-chitosan or a combination of the aforementioned organic and inorganic compounds. In certain circumstances, organic polymer or organic-inorganic hybrid polymers can be heat treated to yield carbon or inorganic based mesoporous or microporous materials including aerogels.

In the present invention, the silicone-based fire protection material may exhibit a compression strain of ≥10%, ≥15%, ≥20%, ≥25% or ≥30% at 200 kPa.

In an embodiment of the present disclosure, the silicone-based polymeric foam is obtained by curing a curable silicone-based composition comprising:
a) at least one organopolysiloxane having at least two alkenyl groups bonded to silicon per molecule;
b) at least one silicone crosslinker having at least two or at least three hydrogen atoms bonded to silicon (Si—H or —SiH) per molecule,
c) hollow fillers;
d) a hydrosilylation catalyst, and
e) a gas blowing agent.

In the present invention, component a) is well-known in the art; and examples thereof comprises vinyl endblocked polydiorganosiloxanes (i.e., vinyl-terminated PDMS) of the formula:

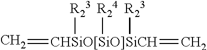

where R³ and R⁴ are selected from the group consisting of alkyl groups having from 1 to 6 carbon atoms per group, phenyl groups, and vinyl groups with at least 50 percent of R⁴ being methyl group. Preferably, the viscosity of component a) is from 8000 cst to 20000 est, from 8000 cst to 16000 cst, from 8000 cst to 14000 cst, from 8000 est to 12000 cst or from 8000 cst to 10000 cst at 25 °C.

In some embodiments of the present disclosure, the alkenyl groups contained in component a) may comprise from 2 to 14 carbon atoms, 4 to 12 carbon atoms or 6 to 10 carbon atoms; preferably, the alkenyl groups are chosen from the group consisting of vinyl, allyl, hexenyl, decenyl and tetradecenyl, and most preferably the alkenyl groups are vinyl groups.

With particular preference, component a) may be incorporated into the curable silicone-based composition in an amount of from 20% to 80% by weight, from 30% to 60% by weight or from 40% to 50% by weight, such as 30.1% by weight, based on the total amount of the curable silicone-based composition.

In the present invention, component b) may be used to adjust crosslink density and can be any silicones having an average of at least two silicon-bonded hydrogen atoms per molecule. The remaining valences of the silicon atoms are satisfied by divalent oxygen atoms or by monovalent alkyl radicals having from 1 to 6 carbon atoms per radical, such as methyl, ethyl, propyl, isopropyl, butyl, and hexyl and phenyl groups. The organohydrogensilicones can be homopolymers, copolymers, and mixtures thereof. Preferably, the organohydrogensilicones is a copolymer of trimethylsiloxy and methylhydrogensilicones or a copolymer of trimethylsiloxy, methylhydrogensilicones and dimethylsilicones. In an embodiment of the present invention, the organohydrogensilocones have an average of at least three silicon-bonded hydrogen atoms per molecule. In an embodiment of the present invention, the viscosity of component b) is from 1 est to 100 est, from 1 cst to 80 est, from 1 est to 60 est, from 1 est to 40 est or from 1 est to 20 cst at 25 °C. In an embodiment of the present invention, component b) comprises 1-5 wt %, 1-4 wt %, 1-3 wt %, 1-2 wt % or 1-1.5 wt % SiH, In an embodiment of the present invention, component b) is hydrogenated silicone oil having a viscosity 20 est at 25 °C and about 1.6 wt % SiH.

With particular preference, component b) may be incorporated into the curable silicone-based composition in an amount of from 4% to 20% by weight, from 6% to 16% by weight or from 8% to 14% by weight, such as 12% by weight, based on the total amount of the curable silicone-based composition.

In the present invention, component c) may be used to adjust hardness and density of the silicone-based fire protection material. Hollow glass beads function to reduce the density of the foam. Hollow glass beads, and in particular hollow glass microspheres are well suited for this application because, in addition to having excellent isotropic compressive strengths, they have the lowest density of any filler that would be useful in the manufacture of high compressive strength foam. The combination of high compressive strength and low density make hollow glass microspheres the filler with numerous advantages according to the invention. According to one embodiment, hollow glass beads are hollow borosilicate glass microspheres also known as glass bubbles or glass microbubbles. According to another embodiment, the hollow borosilicate glass microspheres have true densities ranging from 0.10 gram per cubic centimeter (g/cc) to 0.65 gram per cubic centimeter (g/cc).

According to a preferred embodiment, hollow glass beads are chosen from the 3M™ Glass Bubbles Floated Series (A16/500, G18, A20/1000, H20/1000, D32/4500 and H50/10,000EPX glass bubbles products) and 3M™ Glass Bubbles Series (such as but not limited to K1, K15, S15, S22, K₂O, K25, S32, S35, K37, XLD3000, S38, S38HS, S38XHS, K46, K42HS, S42XHS, S60, S60HS, iM16K, iM30K glass bubbles products) sold by 3M Company. Said glass bubbles exhibit various crush strengths ranging from 1.72 megapascal (250 psi) to 186.15 Megapascals (27,000 psi) at which ten percent by volume of the first plurality of glass bubbles collapses. Other glass bubbles sold by 3M such as 3M™ Glass Bubbles-Floated Series, 3M™ Glass Bubbles-HGS Series and 3M™ Glass Bubbles with Surface Treatment could also be used according to the invention.

According to a preferred embodiment, said glass bubbles are chosen among those exhibiting crush strengths ranging from 1.72 megapascal (250 psi) to 186.15 Megapascals (27,000 psi) at which ten percent by volume of the first plurality of glass bubbles collapses. According to a most preferred embodiment, hollow glass beads are chosen from the 3M™ Glass Bubbles series, S15, K1, K25, iM16K, S32 and XLD3000.

With particular preference, component c) may be incorporated into the curable silicone-based composition in an amount of from 1% to 15% by weight, from 3% to 10% by weight or from 5% to 8% by weight, such as 4.7% by weight, based on the total amount of the curable silicone-based composition.

In the present invention, component d), a hydrosilylation catalyst, can be selected from the group consisting of platinum, palladium, rhodium, nickel, iridium, ruthenium catalysts and mixtures thereof, preferably platinum catalyst, which can efficiently promote the reaction of —SiH groups with vinyl groups and the reaction between —SiH groups and hydroxyl groups to provide hydrogen gas for the foaming process. Particularly preferred is a two-component foamable silicone composition wherein the catalyst is an organoplatinum compound. Particularly preferred is a two-component foamable silicone composition wherein the catalyst is functional organoplatinum compound selected from an (η-diolefin) (α-aryl) platinum complex, an (η-diolefin) (γ-aryl)-platinum complex, an (η-diolefin) (γ-alkyl)-platinum complex, and mixtures thereof. It is possible to use commercially available products in the present invention.

With particular preference, component d) may be incorporated into the curable silicone-based composition in an amount of from 0.10% to 2% by weight, from 0.5% to 1.5% by weight or from 0.8% to 1.3% by weight, such as 1.2% by weight, based on the total amount of the curable silicone-based composition.

In the present invention, component e) may comprise a chemical blowing agent, a physical blowing agent or a mixture of a chemical blowing agent and a physical blowing agent. The curable silicone-based composition may be mechanically blown or may comprise chemical and/or physical blowing agents. In order to avoid the generation of explosive gases and or volatile organics the use of suitable physical blowing agents, including those which are non-flammable and/or inert gas at 0 °C (zero °C) may be utilized.

Alternatively, component e) may comprise a physical liquid blowing agent. When component e) is a physical liquid blowing agent, said physical liquid blowing agent is tailored to undergo a phase change at the temperature of application. When component e) is a physical blowing agent, said phase change at the temperature of application is the main source for the gas that leads to the formation of the foam by replacing all or most of the hydrogen gas generated when using a chemical blowing agent.

When component e) is a physical blowing agent, the physical blowing agent chosen is selected in accordance with its boiling point such that it undergoes a phase change from a liquid to a gaseous state during exposure to atmospheric pressure and the temperature of the cure process, e.g. a temperature less than or equal to 10 °C, alternatively less than or equal to 20′C, alternatively less than or equal to 30 °C, alternatively less than or equal to 40 °C, alternatively less than or equal to 50 °C, alternatively less than or equal to 60 °C, alternatively less than or equal to 70 °C, alternatively less than or equal to 80′C, alternatively less than or equal to 90 °C, alternatively less than or equal to 100 °C. In the case of room temperature vulcanization systems, the physical blowing agent chosen may have a boiling point of between 10 and 30 °C, i.e., such that it undergoes a phase change from a liquid to a gaseous state during exposure to atmospheric pressure within this temperature range.

The amount of physical blowing agent utilized, when component e) is a physical blowing agent, can vary depending on the desired outcome. For example, the amount of physical blowing agent can be varied to tailor final foam density and foam rise profile of the resulting thermal insulation.

Useful physical blowing agents include hydrocarbons, such as pentane, hexane, halogenated, more particularly chlorinated and/or fluorinated, hydrocarbons, for example methylene chloride, chloroform, trichloroethane, chlorofluorocarbons, hydrochlorofluorocarbons (HCFCs), ethers, ketones and esters, for example methyl formate, ethyl formate, methyl acetate or ethyl acetate, in liquid form or air, nitrogen or carbon dioxide as gases. In certain embodiments, the physical blowing agent comprises a compound selected from the group consisting of propane, butane, isobutane, isobutene, isopentane, dimethylether or mixtures thereof. In many embodiments, the blowing agent comprises a compound that is inert.

In various embodiments, the physical blowing agent comprises a hydrofluorocarbon (HFC). “Hydrofluorocarbon” and “HFC” are interchangeable terms and refer to an organic compound containing hydrogen, carbon, and fluorine. The compound is substantially free of halogens other than fluorine.

Examples of suitable HFCs include aliphatic compounds such as 1,1,1,3,3-pentafluoropropane, 1,1,1,3,3-pentafluorobutane, 1-fluorobutane, nonafluorocyclopentane, perfluoro-2-methylbutane, 1-fluorohexane, perfluoro-2,3-dimethylbutane, perfluoro-1,2-dimethylcyclobutane, perfluorohexane, perfluoroisohexane, perfluorocyclohexane, perfluoroheptane, perfluoroethylcyclohexane, perfluoro-1,3-dimethyl cyclohexane, and perfluorooctane; as well as aromatic compounds such as fluorobenzene, 1,2-difluorobenzene; 1,4-difluorobenzene, 1,3-difluorobenzene; 1,3,5-trifluorobenzene; 1,2,4,5-tetrafluorobenzene, 1,2,3,5-tetrafluorobenzene, 1,2,3,4-tetrafluorobenzene, pentafluorobenzene, hexafluorobenzene, and 1-fluro-3-(trifluoromethyl)benzene. In certain embodiments, compounds such as 1,1,1,3,3-pentafluoropropane and 1,1,1,3,3-pentafluorobutane may be preferred due to their increasing availability and ease of use, with 1,1,1,3,3-pentafluorobutane having a higher boiling point than 1,1,1,3,3-pentafluoropropane which may be useful in certain applications. For example, HFCs having a boiling point higher than 30 °C, such as 1,1,1,3,3-pentafluorobutane, may be desirable because they do not require liquefaction during foam processing. In specific embodiments, when component e) is a physical blowing agent, component e) comprises 1,1,1,3,3-pentafluoropropane.

When component e) comprises a chemical blowing agent, it comprises one or more hydroxyl-containing blowing agents which will react with cross-linker (b) in the presence of component (d) the catalyst. When component e) is a chemical blowing agent, comprising one or more hydroxyl-containing blowing agents, each hydroxyl-containing blowing agent has at least one hydroxyl (OH) group, alternatively at least two OH groups, and alternatively three or more OH groups. The OH group(s) can react with the Si—H groups of component (b), thereby generating hydrogen gas, which is relied upon to generate the foam. Each hydroxyl-containing blowing agent may be a suitable alcohol. These may be selected from aliphatic organic alcohols having from 1 to 12 carbon atoms such as low molecular weight alcohols including, but are not limited to, methanol, ethanol, propanol, isopropanol, and the like or alternatively, benzyl alcohol.

In one embodiment the hydroxyl-containing blowing agent may be a diol. Examples of suitable diols include, but are not limited to, methylene glycol, ethylene glycol, diethylene glycol, propylene glycol, dipropylene glycol, butane diol, bisphenol A, 1,4-butanediol, 1,3-propanediol, 1,5-pentanediol, 1,7-heptanediol, 1,2-hexanediol, triethylene glycol, tripropylene glycol neopentyl glycol, and combinations thereof. Alternatively, the hydroxyl-containing blowing agent may be a triol.

In various embodiments, component e), when a hydroxyl-containing blowing agent is selected from the group of low-boiling alcohols. Most (but not all) of such alcohols have a boiling point lower than about 120 °C. The alcohols may or may not be anhydrous, but anhydrous alcohols (containing less than 1 wt. %) water based on weight of alcohol is generally preferred. Other suitable blowing agents are described in U.S. Pat. Nos. 4,550,125, 6,476,080, and US20140024731, which are incorporated herein by reference.

Component e) when a hydroxyl-containing blowing agent is present in an amount to provide an OH content of from about 10 parts per million (ppm) to 50,000 ppm, alternatively about 100 ppm to 20,000 ppm, alternatively about 500 ppm to 10,000 ppm, alternatively about 500 to about 7500 ppm.

In other embodiments, when component e) is a chemical blowing agent, the chemical blowing agent may be selected from the group of Si—OH polymers. In certain embodiments, when a chemical blowing agent, component e) is selected from the group consisting of organosilanes and organosiloxanes having at least one silanol (Si—OH) group. Such compounds can have structures similar to those for the polymers described above for component (a).

Examples of suitable OH-functional compounds include dialkyl siloxanes, such as OH-terminated dimethyl siloxanes. Such siloxanes may have a relatively low viscosity, such as about 15 to about 20,000 mPa·s, about 15 to about 10,000 mPa·s, about 15 to about 5,000 mPa·s, about 15 to about 1,000 mPa·s, or about 15 to about 100 mPa·s. measured at 25 °C. Viscosity may be measured at 25 °C using either a Brookfield™ rotational viscometer with spindle LV-3 (designed for viscosities in the range between −200-400,000 mPa·s) or a Brookfield™ rotational viscometer with spindle LV-1 (designed for viscosities in the range between 15-20,000 mPa·s) for viscosities less than 200 mPa·s and adapting the speed i.e. shear rate according to the polymer viscosity, for example from 0.005 s⁻¹ to 1 s⁻¹ (0.3 to 60 rpm) with, in this instance, 1 s⁻¹ preferred.

In an alternative embodiment of the present invention, component e) may have at least one hydroxyl group, including one, two or more hydroxyl groups, or is a mixture of compounds having at least one hydroxyl group. The hydroxyl group of component e) can react with the silicon-hydrogen group (SiH) of the silicone having at least two —SiH group (hydrosilyl group) to produce hydrogen gas and hence create the cells in the foam. In some embodiments of the present disclosure, component e) is selected from silanols, alcohols, water, and a mixture thereof.

In one embodiment of the present disclosure, alcohols may have from 1 to 12 carbon atoms. Examples of the alcohols are such as methanol, ethanol, propanol, isopropanol, and butanol. The alcohol can react with the hydrogen atoms on silicon in the presence of the platinum catalyst to generate additional hydrogen gas. Preferably, the alcohol is a monohydroxyl alcohol. When a monohydroxyl alcohol is used, there is no corresponding crosslink formed, so the resulting foam tends to have fewer crosslinks than if the alcohol was not present. Foams formed by using alcohols tend to have lower density than when the alcohols are not present.

With particular preference, component e) may be incorporated into the curable silicone-based composition in an amount of from 0.10% to 50% by weight, from 0.50% to 3% by weight or from 1.0% to 2% by weight, such as 1.9% by weight, based on the total amount of the curable silicone-based composition.

In some embodiments of the present disclosure, the curable silicone-based composition further comprises:
f) at least one additive selected from an inhibitor which slows curing rate, a reactive diluent which reacts through hydrosilylation reaction, a pigment, a dye, clays, a surfactant, hydrogenated castor oil, wollastonite, aluminium trihydrate, magnesium hydroxide, halloysite, huntite hydromagnesite, expandable graphite, zinc borate, mica and a fumed silica.

In some embodiments of the present disclosure, the curable silicone-based composition further comprises:
g) at least one selected from the group consisting of a flame-retardant additive, a curing catalyst, a rheology modifier, a wetting-additive, a surface treatment agent, a colorant, a filler other than the hollow filler, a hydrosilylation catalyst inhibitor, a profoamer, an anti-oxidant additive, a biocide, a reinforcing resin, a ultraviolet (UV) stabilizer additive and an adhesion promoter additive.

In the present invention, the silicone-based fire protection material can be further improved in flame retardancy by adding a flame retardant additive. Generally, there is present from 0 to 40 percent by weight, from 10 to 30 percent by weight, from 15 to 25 percent by weight of flame retardant additives, which depends on flame retardant requirement of the silicone-based fire protection material. The flame retardant additive may comprises non-flammable fibers and sulfur-free carbon black. The non-flammable fibers are thought to aid in retaining the char formed when the foam is subjected to flame, to protect the foam under the charred surface. The nonflammable fibers can be selected from such fibers as carbon fibers, ceramic fibers, and aramide fibers, with ceramic fibers being preferred. The fibers should be fine fibers with average diameters of less than 5 micrometres and lengths of less than 100 millimetres so that the fibers can be evenly and easily distributed throughout the mixture. Preferably, there is present from 1 to 5 percent by weight of the non-flammable fibers and 1 to 5 percent by weight of sulfur-free carbon black. The carbon black added can be any of the usual sulfur-free carbon blacks used as additives in silicone elastomers cured with a platinum catalyst. The carbon black is sulfur-free because sulfur might interfere with the cure.

In some embodiments of the present disclosure, the flame retardant additive comprises halogenated flame retardant additive and/or non-halogenated flame retardant additive, in which examples of the halogenated flame retardant additive comprise brominated flame retardant additive such as brominated polymer or oligomers, brominate styrene-butadiene-styrene copolymer, and preferably combinations of the brominated flame retardant additives with antimony trioxide for forming Br—Sb synergetic system; and examples of the non-halogenated flame retardant additive may comprise ammonium polyphosphate, melamine polyphosphate, aluminum hydroxide, magnesium hydroxide, expandable graphite. In the present invention, the flame retardant additives may be dispersed in or distributed throughout the silicone-based polymeric binder (i.e., a polymer matrix) with a loading in the range of 0~60 mass % of the dried material. The flame retardant additives with a loading>60 mass % may result to insufficient thermal insulation performance required in Battery fire protection application.

In the present invention, the (hydrosilylation catalyst) inhibitor can slow the reaction rate so that mixing can be completed before the mixture starts to form a foam. Examples of the hydrosilylation catalyst inhibitor comprise methylvinylcyclosiloxane, tetravinyltetramethyl-cyclotetrasiloxane (vinyl D4), ethynylcyclohexanol (ECH) and mixtures thereof. With particular preference, the hydrosilylation catalyst inhibitor may be incorporated into the curable silicone-based composition in an amount of from 0% to 2% by weight, from 0.5% to 1.5% by weight or from 0.8% to 1.2% by weight, such as 0.7% by weight, based on the total amount of the curable silicone-based composition, which depends on desired curing speed.

The filler other than the hollow filler comprises, but not limited to, (fumed) silica, diatomaceous earth, crushed quartz, zinc oxide, huntite, aluminum hydroxide, CaCO₃ and hydromagnesite, fibrous potassium titanate, or other well-known fillers for silicone-based fire protection material. The maximum amount of the filler other than the hollow filler used will depend upon the viscosity of the curable silicone-based composition.

In the present invention, the profoamer may be used to adjust morphology of the foam as formed, which results in modified foams with smaller, more uniform cells, preferably primarily closed and allows the production of foams having different combinations of properties, such as density, compressibility and resiliency. The profoamer comprises a resinous, benzene-soluble organosiloxane copolymers wherein the repeating units include, but are not limited to, SiO_{4/2} units, (CH₃)₃SiO_{1/2} units and fluorine-containing units comprising at least one perfluorinated carbon atoms. Each of the fluorine-containing units also includes one or two silicon atoms that are joined to the fluorine-containing carbon atoms by a sequence of at least two methylene (—CH₂—) units or by an oxygen atom that is, in turn, bonded to said sequence. Examples of the profoamer comprise fluorinated silicone resin.

With particular preference, the profoamer may be incorporated into the curable silicone-based composition in an amount of from 0% to 10% by weight, from 3% to 8% by weight or from 5% to 6% by weight, such as 7.5% by weight, based on the total amount of the curable silicone-based composition, which depends on desired curing speed.

The reinforcing resin may improve mechanical requirement, and examples thereof comprise blend of PDMS and resin, in which the amount of resin is 35% by weight, 0.84% by weight of vinyl and have viscosity of 5000 cst at 25 °C, and etc. With particular preference, the reinforcing resin may be incorporated into the curable silicone-based composition in an amount of from 0% to 50% by weight, from 10% to 40% by weight or from 20% to 30% by weight, such as 30.4% by weight, based on the total amount of the curable silicone-based composition.

The rheology modifier is used for tuning viscosity of wet slurry, e.g., in amount of 0~2 mass % in wet slurry. The curing catalyst comprises dioctyltin dilaurate or others, depending on the curing chemistry. The wetting additive is used for surface wetting of hydrophobic filler. The colorants may impart desired colors to the silicone-based fire protection material.

In the present invention, the method of producing said silicone-based fire protection material comprises following steps:
Step (I): a step of providing Part A comprising a) at least one organopolysiloxane having at least two alkenyl groups bonded to silicon per molecule and e) a gas blowing agent;
Step (II): a step of providing Part B comprising b) at least one silicone crosslinker having at least two hydrogen atoms bonded to silicon per molecule and optionally e) a gas blowing agent being a physical blowing agent;
Step (III): a step of mixing Part A with Part B to form the curable silicone-based composition;
Step (IV): a step of coating the curable silicone-based composition as wet-slurry layer onto a substrate which optionally have a release layer, and
Step (V): a step of forming the silicone-based fire protection material by curing and foaming the curable silicone-based composition as coated.

In some embodiments of the present disclosure, components (a) to (g) can be combined in any combination to make two parts for storage as long as the chemical blowing agent as a gas blowing agent and organopolysiloxane containing alkenyl groups are not present with the silicone crosslinker comprising Si—H. For best shelf life, it is desirable not to have the hydrosilylation catalyst and organopolysiloxane in the same package. In some embodiments of the present disclosure, components c), d), f) and g) may be independently added into Part A, Part B or both. In the method of producing the silicone-based fire protection material of the present invention, when a physical blowing agent is utilized as a gas blowing agent, it may be incorporated in Part A, Part B or both.

In embodiments of the present invention, the method of producing said silicone-based fire protection material may further comprise: before mixing Part A with Part B, adding a flame-retardant additive, a curing catalyst, a rheology modifier, a wetting-additive, a surface treatment agent, a colorant, a filler other than the hollow filler, an anti-oxidant additive, a biocide, a ultraviolet (UV) stabilizer additive and an adhesion promoter additive to Part A, Part B or both.

In embodiments of the present invention, the method of producing said silicone-based fire protection material may further comprise: after mixing Part A with Part B, adding a flame-retardant additive, a curing catalyst, a rheology modifier, a wetting-additive, a surface treatment agent, a colorant, a filler other than the hollow filler, an anti-oxidant additive, a biocide, a ultraviolet (UV) stabilizer additive and an adhesion promoter additive to the curable silicone-based composition.

In embodiments of the present invention, the method of producing said silicone-based fire protection material may further comprise: the wet-slurry layer of the curable silicone-based composition has a thickness of from 0.2 to 10.0 mm, from 0.2 to 6.0 mm, from 0.2 to 2.0 mm, from 0.2 to 1.0 mm, from 1.0 to 10.0 mm, from 1.0 to 6.0 mm, from 1.0 to 2.0 mm, from 2.0 to 10.0 mm, from 2.0 to 6.0 mm or from 6.0 to 10.0 mm in Step (IV).

In embodiments of the present invention, the method of producing said silicone-based fire protection material may further comprise: the step of controlling the viscosity and/or flowability of the curable silicone-based composition by a rheology modifier before or at the same timing of Step (IV).

In embodiments of the present invention, the method of producing said silicone-based fire protection material may further comprise: removing the silicone-based fire protection material from the substrate such as a release paper.

In the present invention, the silicone-based fire protection material may be used in a secondary battery pack comprising at least one battery module casing, in which the casing comprises a plurality of battery cells which are electrically connected to one another. The preferred shapes for said battery cells are prismatic or pouch shapes, which is preferably protected by said silicone-based fire protection material.

In embodiments of the present invention, a battery package structure is described wherein said silicone-based fire protection material is fully or partially arranged into a space between at least two adjacent individual battery cells. When said battery package structure is prepared, the silicone-based fire protection material can be cured prior to its arranging into the space between at least two adjacent individual battery cells. In this production method of the battery package structure, “cured” silicone-based fire protection material can be arranged (including inserted) fully or partially into a space between at least two adjacent individual battery cells to prevent the heat transfer from the hot surface of the “fired” cell caused by its thermal runaway propagation to the adjacent good cell.

Also, the silicone-based fire protection material can be arranged in the space between at least two adjacent individual battery cells through curing reaction of the curable silicone-based composition in said space. In this embodiments of the present invention, the battery package structure is prepared using curable silicone-based composition which can be cured into said silicone-based fire protection material. More specifically, this production method of the battery package structure comprises following steps: Step (B-I): a step of filling a space between at least two adjacent individual battery cells fully or partially with the curable silicone-based composition according to any one of claims 13 to 14 as wet-slurry layer, and Step (B-II): a step of forming a silicone-based fire protection material in the space between at least two adjacent individual battery cells by curing and foaming the curable silicone-based composition.

Considering its procedural requirements in the battery assembly process or required fire-protection performance of the battery package structure, any of said production methods can be employed to arrange the silicone-based fire protection material into the space between at least two adjacent individual battery cells.

The silicone-based fire protection material fills partially or fully open space of said battery module casing and/or covering partially or totally said battery cells, and/or covering partially or totally said module casing, and optionally a lid covering the battery module casing. The silicone-based fire protection material is obtained by dispersing hollow fillers into the silicone-based polymeric foam, coating to certain wet thickness, and forming the final material with hollow fillers and gas bubbles. The silicone-based fire protection material can also be assembled between water cooling plate and metal plate of battery case to prevent heat diffusion between water cooling plate and metal plate of battery case. The silicone-based fire protection material of the present invention could be pre-fabricated and then assembled into the battery case. The silicone-based fire protection material of the present invention can also be fabricated by potting the wet slurry obtained by dispersing hollow fillers into liquid silicone composite into the cave between cells in the battery case, and forming final cured and foamed material.

### EXAMPLES

Some embodiments of the invention will now be described in the following examples, wherein all parts and percentages are by weight unless otherwise specified.

The information of the raw materials used in Examples is listed in the following Table 1:

TABLE 1
Raw materials used in Examples

| Ingredient | | Chemical Description, Chemical | |
|---|---|---|---|
| Type | Name | formula, or Structure | Source |
| Organopolysiloxane | P-1 | Vinyl-terminated PDMS, viscosity | Dow Chemical |
| | | 12000 cst | |
| Filler 1 | F-1 | Hydromagnesite, d50 4 μm | Huaya Superfine |
| | | | Powder Co. Ltd. |
| Filler 2 | F-2 | Glass bubbles, d50 55 μm, density | 3M |
| | | 0.15 g/cc | |
| Filler 3 | F-3 | Glass bubbles, d50 40 μm, density | 3M |
| | | 0.32 g/cc | |
| Reinforcing | R-1 | Blend of PDMS and resin, 35% | Dow Chemical |
| Resin | | resin, viscosity 5000 cst, and 0.84 | |
| | | wt % vinyl. | |
| Inhibitor | INH-1 | Methyl vinyl siloxane cyclic | Dow Chemical |
| Catalyst | CAT-1 | Platinum catalyst | Dow Chemical |
| Profoamer | PF-1 | Fluorinated silicone resin | Dow Chemical |
| Blowing | B-1 | 1-Propanol | SinoPharm |
| agent | | | |
| Crosslinker | CX-1 | Hydrogenated silicone oil, viscosity | Dow Chemical |
| | | 20 cst, and about 1.6 wt % SiH | |

### Inventive Examples 1-2 (IE 1~2) and Comparative Examples 1-2 (CE 1-2)

In Inventive Examples 1-2 of the present disclosure, the silicone-based fire protection materials were produced using those raw materials and their amounts described in Table 2. Comparative Examples 1-2 were provided here as control.

TABLE 2
Formulations used in Examples and Comparative Examples

| | | | | | |
|---|---|---|---|---|---|
| Ingredient Type | Name | CE1 | CE2 | IE1 | IE2 |

Part A:

| | | | | | |
|---|---|---|---|---|---|
| Organopolysiloxane | P-1 | 55 | 31.9 | 31.0 | 30.4 |
| Filler 1 | F-1 | | 24.5 | 23.8 | 23.4 |
| Filler 2 | F-2 | | | 2.9 | 4.7 |
| Filler 3 | F-3 | 10 | | | |
| Resin | R-1 | 35 | 31.9 | 31.0 | 30.4 |
| Catalyst | CAT-1 | 0.5 | 1.3 | 1.2 | 1.2 |
| Inhibitor | INH-1 | | 0.7 | 0.7 | 0.7 |
| Profoamer | PF-1 | | 7.8 | 7.6 | 7.5 |
| Blowing agent | B-1 | | 2.0 | 1.9 | 1.9 |

Part B:

| | | | | | |
|---|---|---|---|---|---|
| Organopolysiloxane | P-1 | 55 | 31.6 | 30.7 | 30.1 |
| Filler | F-1 | | 24.3 | 23.6 | 23.1 |
| Filler | F-2 | | | 2.8 | 4.6 |
| Filler | F-3 | 10 | | | |
| Resin | R-1 | 30 | 31.6 | 30.7 | 30.1 |
| Crosslinker | CX-1 | 5 | 12.6 | 12.3 | 12.0 |

For IE1~2 and CE1~2, they involved six steps:
Step 1: Formulating Part A as a wet slurry;
Step 2: Formulating Part B as a wet slurry;
Step 3: Mixing Part A with Part B to form a curable silicone-based composition as a mixed wet slurry;
Step 4: Coating the mixed wet slurries on a substrate wich has a release layer;
Step 5: Curing and foaming the mixed wet slurries to form a silicone-based fire protection material; and
Step 6: Testing thermal insulation performance of the silicone-based fire protection material at high temperature.

Detail description about steps 1-6 was provided as below:

### Step 1: Formulating Part A

Into a 1 liter plastic cup, P-1, R-1, CAT-1, INH-1 (if required), B-1 and PF-1 (if required) were added and mixed with a Cowles blade, with a stirring speed at 300 rpm to form homogeneous slurry. Then F-1 was slowly added under stirring at 300 rpm to ensure dispersion of F-1 and avoid agglomeration. After it was fully dispersed and viscosity build up, F-2 and/or F-3 (if required) was added gradually under stirring at 300 rpm, to make homogeneous slurry.

### Step 2: Formulating Part B

Into a 1 liter plastic cup, P-1, R-1 and CX-1 were added and mixed with a Cowles blade, with a stirring speed at 300 rpm to form homogeneous slurry. Then F-1 was slowly added under stirring at 300 rpm to ensure dispersion of F-1 and avoid agglomeration. After it was fully dispersed and viscosity build up, F-2 and/or F-3 (if required) was added gradually under stirring at 300 rpm, to make homogeneous slurry.

Step 3: Mixing Part A with Part B

Part A was mixed with Part B under stirring at 300 rpm to make homogeneous slurry.

### Step 4: Coating the Wet Slurries on a Substrate

The slurry obtained in Step 3 was coated on PTFE sheet with a knife doctor, so as to form a wet sheet with a thickness of 1 mm.

### Step 5: Curing and Foaming the Mixed Wet Slurries

The wet sheet obtained in Step 4 was dried at 90 °C oven for 1 hour, to get a dried sheet.

### Step 6: Testing Thermal Insulation Performance at High Temperature.

The dried sheet was cut into 8 cm×8 cm square, put on a heat stage stabilized at 600 °C temperature, mounted Al plate with two K-type thermal couples with O.D. at 0.5 mm partially embedded in 0.4 mm groove closely contact the back surface of the specimen to record back temperature. All surfaces of the Al plate were well covered by thermal insulative asbestos board to control heat diffusion. Steel loading was further mounted on Al plate to make 0.03 Mpa pressure on specimen. Illustration of the set up was referred to FIG. 1. All mounting was completed in 10 second since the specimen attached to the heat stage. Heat stage temperature of 600 °C was calibrated by mounting a square 8 cm×8 cm aerogel sheet/pad with thickness of 4±0.2 mm onto the Al plate, with one thermocouple on the center the sheet directly contacting heat stage surface. The calibration lasted at least 20 min for a stable 600 °C heat stage surface before starting thermal insulation performance test. In the test, back temperature was recorded from the time the specimen attached to the heat stage. The test lasted for 20 min. Original thickness of sheet specimen was measured at four corners, and an average thickness was calculated. During the testing, a feeler gauge was used to insert between the heat stage and Al plate to measure thickness right before ending the test. Back temperature change with testing duration was recorded.

TABLE 3
Thermal insulation performance testing results

| | Performance | | | | | |
|---|---|---|---|---|---|---|
| Tested Property | Criteria | | CE1 | CE2 | IE1 | IE2 |
| Viscosity (mPa*s) | <20,000 | mPas | 30,000 | 5,000 | 16,000 | 18,000 |
| Density (g/cm³) | <0.8 | g/cm³ | 0.80 | 0.40 | 0.45 | 0.34 |
| Hardness (Shore A) | >10 | | 43 | 12 | 32 | 40 |
| Flame retardant | UL 94 V0 | | HB | V-0 | V-0 | V-0 |
| Thermal insulation | <230 | °C | 231.4 | 233.9 | 216.5 | 213.4 |

| (Back temperature °C) | | | | | |
|---|---|---|---|---|---|
| Dielectric strength | >5 | 10.7 | 7.3 | 6.8 | 6.3 |
| (kv/mm) | | | | | |
| Volume resistance | >2.5 × 10¹⁵ | 2.5 × 10¹⁵ | 2.7 × 10¹⁵ | 6.2 × 10¹⁵ | 2.2 × 10¹⁵ |
| (ohm*cm) | | | | | |
| Hollow filler volume | 1-60 | 28.4 | 0 | 8.4 | 10.4 |
| fraction (%) | | | | | |
| Gas bubble volume | 5-90 | 0 | 64.0 | 51.8 | 60.1 |
| fraction (%) | | | | | |
| Compression strain at | >10 | 7.97 | 38.6 | 29.7 | 20.2 |
| 200 kPa (%) | | | | | |

Compared with CE1 which was free of blowing agent, the inventive IE1 and IE2 both exhibit lower density and excellent thermal insulation performance. The viscosity was about 16000 mPa*s, which was much suitable for roll-to-roll casting fabrication process and for potting process. The thermal insulation performance and flame retardancy were also significantly enhanced. Due to existence of gas bubble with certain volume fraction, their compression strain at 200 kPa met the requirement for the application of battery pack with prismatic or pouch cells.

CE1 contained about 10% hollow glass beads, which significantly increased viscosity of the curable silicone-based composition. The density of CE1 was 0.8 g/cc, which was higher than the inventive IE1 and IE2. The thermal insulation test showed the back temperature of CE1 reached 231.4 °C, and was close to the critical temperature (250 °C) which can result in thermal runaway of adjacent battery cell. CE1's compression strain at 200 kPa was only 7.97%, lower than the minimum requirement as demanded to absorb the thickness variation of prismatic cell during module or pack assembly.

CE2 was a H₂-blown silicone foam without hollow glass beads. It had low density and low hardness. However, the thermal insulation performance was poor because it can be easily compressed in thermal insulation test.

IE1 and IE2 contained less than 5 vol % hollow glass beads, and their viscosities were much lower. It was because 1-propanol blowing agent was reacted with Si—H crosslinker and released H₂ gas which created abundant pores/voids during the curing process. Although the density in IE1 and IE2 was low, IE1 and IE2 had higher hardness, which enabled IE1 and IE2 to have low thermal conductivity and suitable cushion performance, thereby better fitting for thermal barrier applications between individual cells in battery pack.

### Testing and Evaluation

### Viscosity

The viscosity of the curable silicone-based composition was measured according to ASTM D1084.

### Density

The density of the silicone-based fire protection material was measured according to ASTM D792.

### Hardness (Shore A)

The hardness of the silicone-based fire protection material was measured according to ASTM D 2240.

### Flame Retardant Property

The silicone-based fire protection material was measured for Flame retardant property according to UL 94.

### Thermal Insulation (Back Temperature °C)

FIG. 1 illustrated the experimental set up of thermal insulation performance test. An 8×8 cm² sample was placed on a heater at 600 °C for 20 min. Two thermo couples were placed on the backside of sample to monitor the temperature. An aluminum block was put on the top of sample to mimic adjacent battery cells in a battery module. On the top of the aluminum block, some iron blocks were added to mimic the pressure (0.03 Mpa) during thermal runaway process.

### Electrical Insulation

The silicone-based fire protection material was measured for dielectric strength according to ASTM D 149 and for volume resistance according to ASTM D257.

### Hollow Filler Volume Fraction

The volume fraction of hollow filler was calculated via below equation.

Rᵥₒₗᵤₘₑ=R_{weight}×ρ_{foam}/ρ_{hollow filler}

Rᵥₒₗᵤₘₑ is the volume fraction of hollow filler, R_{weight} is the weight fraction of hollow filler, ρ_{foam} is the density of foam, ρ_{hollow filler} is the density of hollow filler.

### Gas Bubble Volume Fraction

The volume fraction of gas bubble was calculated via below equation.

R_{gas}=1−Rᵥₒₗᵤₘₑ−(1−R_{weight})×ρ_{foam}/ρ_{slurry}

R_{gas} is the volume fraction of gas bubble, Rᵥₒₗᵤₘₑ is the volume fraction of hollow filler, R_{weight} is the weight fraction of hollow filler, ρ_{foam} is the density of foam, ρ_{slurry} is the density of non-cured formulation without hollow filler, which is 1.1 g/cc for the formulation of examples.

### Compression Strain

The compression strain is measured by Instron 5566. The size of specimen is 36 mm 36 mm*3.4 mm; and the compression speed is controlled at 1 mm/min.

1. A silicone-based fire protection material having a foam structure in which hollow fillers having a d₅₀ of 10-200 microns are bound in a silicone-based polymeric foam comprising gas bubbles, wherein the silicone-based fire protection material has a density of 0.1 g/cc to 0.8 g/cc and a Shore A hardness of 1-40, and the silicone-based polymeric foam has a gas bubble size d₅₀ of 10-1000 microns.

2. The silicone-based fire protection material according to claim 1, wherein the hollow fillers have a volume fraction of 1-60%, based on total volume of the silicone-based fire protection material.

3. The silicone-based fire protection material according to claim 1, wherein the gas bubbles have a volume fraction of 5-90%, based on total volume of the silicone-based fire protection material.

4. The silicone-based fire protection material according to claim 1, wherein the hollow fillers are selected from hollow glass beads, aerogel particles, perlite beads, hollow ceramic beads, floating beads and polymer hollow beads.

5. The silicone-based fire protection material according to claim 1, wherein the silicone-based polymeric foam is obtained by curing a curable silicone-based composition comprising:
a) at least one organopolysiloxane having at least two alkenyl groups bonded to silicon per molecule,
b) at least one silicone crosslinker having at least two hydrogen atoms bonded to silicon per molecule,
c) hollow fillers,
d) a hydrosilylation catalyst, and
e) a gas blowing agent.

6. The silicone-based fire protection material according to claim 5, wherein the curable silicone-based composition further comprises:
f) at least one additive selected from an inhibitor which slows curing rate, a reactive diluent which reacts through hydrosilylation reaction, a pigment, a dye, clays, a surfactant, hydrogenated castor oil, wollastonite, aluminium trihydrate, magnesium hydroxide, halloysite, huntite hydromagnesite, expandable graphite, zinc borate, mica and a fumed silica.

7. The silicone-based fire protection material according to claim 5, wherein the curable silicone-based composition further comprises:
g) at least one selected from the group consisting of a flame-retardant additive, a curing catalyst, a rheology modifier, a wetting-additive, a surface treatment agent, a colorant, a filler other than the hollow filler, an anti-oxidant additive, a biocide, an ultraviolet (UV) stabilizer additive and an adhesion promoter additive.

8. The silicone-based fire protection material according to claim 1, which is applied for a battery package.

9. The silicone-based fire protection material according to claim 1, wherein the silicone-based fire protection material exhibits a compression strain of ≥10% at 200 kPa.

10. A battery package structure wherein the silicone-based fire protection material according to claim 1, is fully or partially arranged into a space between at least two adjacent individual battery cells.

11. The battery package structure according to claim 10, wherein the battery cells are selected from prismatic cell and pouch cell.

12. The battery package structure according to claim 10, wherein the silicone-based fire protection material is silicone-based which is cured prior to its arranging into the space between at least two adjacent individual battery cells.

13. The battery package structure according to claim 10, wherein the silicone-based fire protection material is a cured silicone-based product through curing reaction of a curable silicone-based composition in the space between at least two adjacent individual battery cells, wherein the curable silicone-based composition comprises:
a) at least one organopolysiloxane having at least two alkenyl groups bonded to silicon per molecule,
b) at least one silicone crosslinker having at least two hydrogen atoms bonded to silicon per molecule,
c) hollow fillers,
d) a hydrosilylation catalyst, and
e) a gas blowing agent.

14. A curable silicone-based composition which forms into the silicone-based fire protection material according to claim 1 through curing reaction, the curable silicone-based composition comprising:
a) at least one organopolysiloxane having at least two alkenyl groups bonded to silicon per molecule,
b) at least one silicone crosslinker having at least two hydrogen atoms bonded to silicon per molecule,
c) hollow fillers,
d) a hydrosilylation catalyst, and
e) a gas blowing agent.

15. The curable silicone-based composition according to claim 14, wherein each of the alkenyl groups comprises from 2 to 14 carbon atoms.

16. A method of producing the silicone-based fire protection material according to claim 1, comprising the following steps:
(I) providing a Part A comprising a) at least one organopolysiloxane having at least two alkenyl groups bonded to silicon per molecule and e) a gas blowing agent;
(II) providing a Part B comprising b) at least one silicone crosslinker having at least two hydrogen atoms bonded to silicon per molecule and optionally e) a gas blowing agent being a physical blowing agent;
(III) mixing Part A with Part B to form a curable silicone-based composition;
(IV) coating the curable silicone-based composition as a wet-slurry layer onto a substrate which optionally has a release layer, and
(V) forming the silicone-based fire protection material by curing and foaming the curable silicone-based composition as coated.

17. The method of producing the silicone-based fire protection material according to claim 16, wherein the wet-slurry layer of the curable silicone-based composition has a thickness of from 0.2 to 10.0 mm in step (IV).

18. The method of producing the silicone-based fire protection material according to claim 16, further comprising a step of controlling the viscosity and/or flowability of the curable silicone-based composition by adding a rheology modifier before or at the same timing of step (IV).

19. A method of producing the battery package structure according to claim 10, comprising a step of arranging the silicone-based fire protection material fully or partially into a space between at least two adjacent individual battery cells.

20. A method of producing the battery package structure according to claim 10, comprising the following steps:
(B-I) filling a space between at least two adjacent individual battery cells fully or partially with a curable silicone-based composition as a wet-slurry layer, and
(B-II) forming the silicone-based fire protection material in the space between at least two adjacent individual battery cells by curing and foaming the curable silicone-based composition.
